(19) United States
(12) Patent Application Publication
(10) Pub. No.: US 2019/0238746 A1
(43) Pub. Date: Aug. 1, 2019

(54) Capturing Images at Locked Device Responsive to Device Motion

(71) Applicant: Lenovo (Singapore) Pte. Ltd., Singapore (SG)

(72) Inventors: Russell S. VanBlon, Raleigh, NC (US); John C. Mese, Cary, NC (US); Nathan J. Peterson, Oxford, NC (US)

(21) Appl. No.: 15/881,735

(22) Filed: Jan. 27, 2018

(51) Int. Cl. H04N 5/232; G06F 9/48

(52) U.S. Cl. CPC H04N 5/23219; H04N 5/23258; G06F 9/4806

(57) ABSTRACT

An approach is disclosed that detects a motion at a locked device, such as a smart phone, with the device including a digital camera. An image request is received at the locked device following the detection, whereupon a digital image is captured using the digital camera of the locked device.

### BACKGROUND

Photo opportunities can quickly be lost when using a locked smart phone to take pictures. Some photo gestures exist, but these have particular drawbacks. Drawbacks of these gestures are that even when the user is familiarized with the gesture, the gesture still requires time for the user to perform the gesture before the user raises the device to take a picture using the digital camera on the device. In addition, the user must know that the gesture exists and enable it, many users are unaware of its existence or forget that the gesture is available when wanting to take a quick shot. In addition, other traditional techniques allow for the camera app to be launched directly from the lock screen in limited mode. Drawbacks of these traditional techniques are that the user must first turn on the screen and, even if the screen is already turned on or if it turns on with motion of the device, the technique still requires time for the user to press the camera button on the device before the user raises the camera into position.

### SUMMARY

An approach is disclosed that detects a motion at a locked device, such as a smart phone, with the device including a digital camera. An image request is received at the locked device following the detection, whereupon a digital image is captured using the digital camera of the locked device.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting components used in an approach that captures digital images at a locked device responsive to motion detected at the locked device;

FIG. 4 is a flowchart showing configuration steps used to set up user preferences at a device in order to capture digital images at the device responsive to detected device motion;

FIG. 5 is a flowchart showing steps used to capture digital images at the device responsive to detected device motion; and

FIG. 6 is a flowchart showing steps used to perform digital camera quick launch functionality responsive to detected motion.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

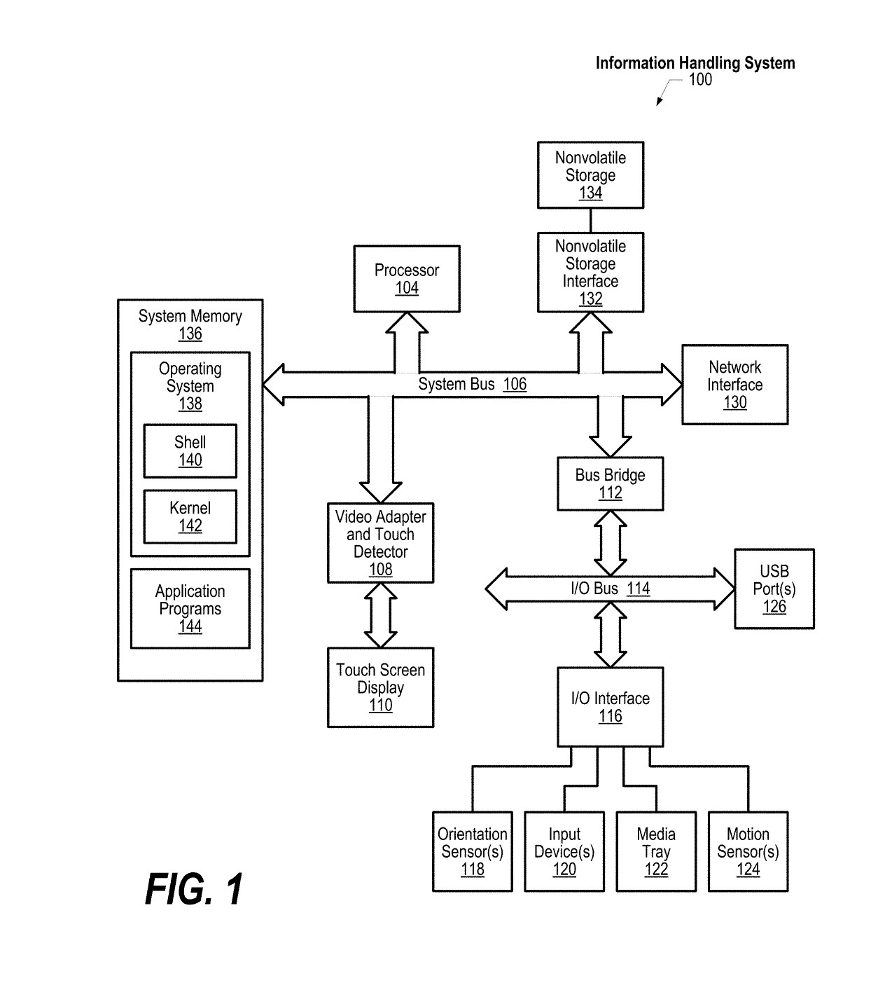

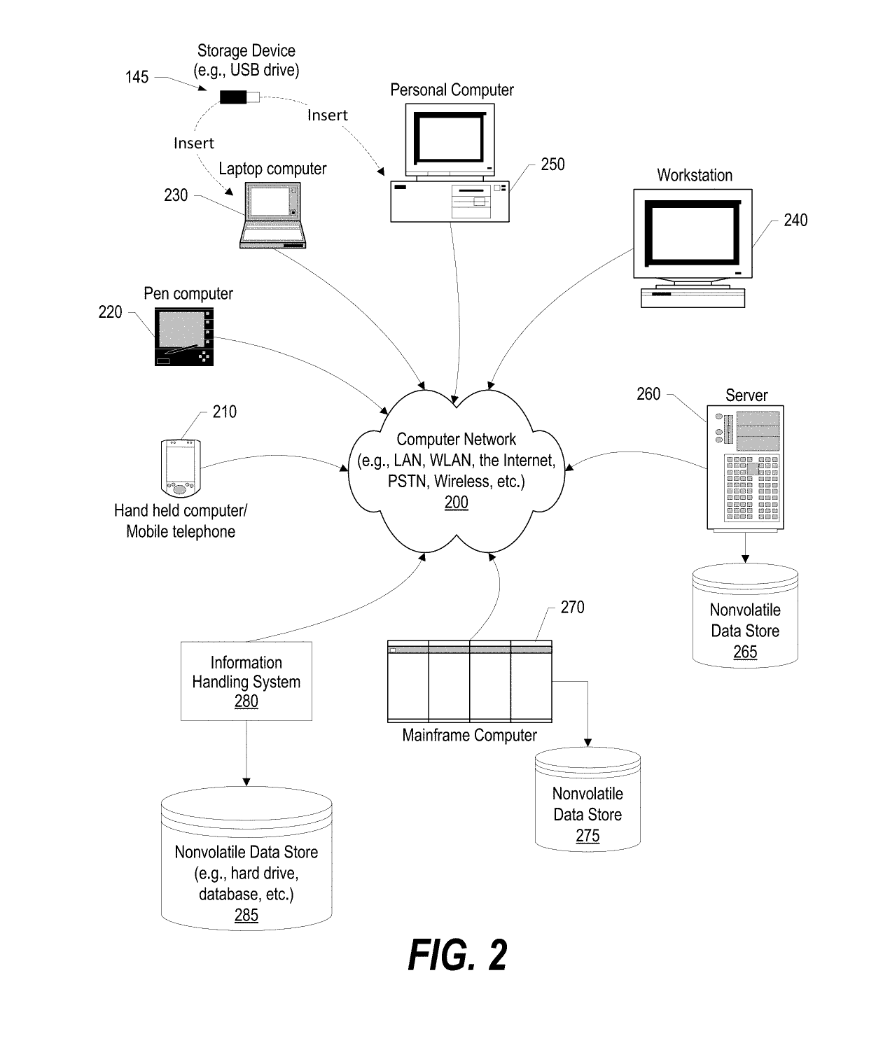

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Note that some or all of the exemplary architecture, including both depicted hardware and software, shown for and within information handling system 100 may be utilized by a software deploying server, such as one of the servers shown in FIG. 2.

Information handling system 100 includes processor 104 that is coupled to system bus 106. Processor 104 may utilize one or more processors, each of which has one or more processor cores. Video adapter 108, which drives/supports touch screen display 110, is also coupled to system bus 106. In one embodiment, touch screen display 110 is able to read a user's fingerprint when pressed against the screen. System bus 106 is coupled via bus bridge 112 to input/output (I/O) bus 114. I/O interface 116 is coupled to I/O bus 114. I/O interface 116 affords communication with various I/O devices, including orientation sensor 118, input device(s) 120, media tray 122 (which may include additional storage devices such as CD-ROM drives, multi-media interfaces, etc.), motion sensor 124, and external USB port(s) 126. Input devices 120 include a digital camera accessible by at least one of the processors. In one embodiment, input devices 120 further includes a fingerprint reader accessible to at least one of the processors that is able to read a fingerprint pressed against the reader.

Orientation sensor(s) 118 are one or more sensors and/or associated logic that senses the physical/spatial orientation of information handling system 100. For example, a simple gravity detector can tell if the information handling system is being held right-side-up, upside down, parallel to or perpendicular to the ground (e.g., a walking surface), at some other angle relative to the ground, etc. In another example, orientation sensor 118 is a set of accelerometers, strain gauges, etc. that provide real-time information describing the physical orientation of information handling system 100 in three-dimensional space, including such orientation with respect to the earth/ground/floor. One or more of these orientation sensors determine if the display screen layer is positioned in a “portrait” mode or a “landscape” mode.

Motion sensor(s) 124 include one or more sensors and/or associated logic that senses the direction, speed, and/or acceleration of movement of information handling system 100 and components such as the keyboard layer, touch layer, and display screen layer. For example, a combination of accelerometers, strain gauges, etc. (described above with respect to orientation sensor 118) can also be used to detect how fast and in what direction information handling system 100 or the individual components is moving, as well as the acceleration of movement of information handling system 100 or the individual components. For example, motion sensor 124, either alone or in combination with the orientation sensor 118 described above, is able to detect if information handling system 100 is being handed from one person to another based on the rate of acceleration during the hand-off (e.g., faster than normal walking acceleration), the yaw orientation of information handling system 100 during the hand-off (e.g., a rotating movement indicating that the computer is being turned around for another person to see during a hand-off of the computer from one person to another), the pitch orientation of information handling system 100 during the hand-off (e.g., the front of information handling system 100 being tilted upwards during the hand-off of the computer from one person to another), and/or the roll orientation of information handling system 100 during the hand-off (e.g., a side of the computer rolling upwards during the hand-off of the computer of the computer from one person to another). In one embodiment, motion sensor 124 (alone or in combination with orientation sensor 118) is able to detect an oscillating motion of information handling system 100, such as that motion created with a user is walking and holding a tablet computer in her hand (and at her side) while swinging her arms forward and backward.

Nonvolatile storage interface 132 is also coupled to system bus 106. Nonvolatile storage interface 132 interfaces with one or more nonvolatile storage devices 134. In one embodiment, nonvolatile storage device 134 populates system memory 136, which is also coupled to system bus 106. System memory includes a low level of volatile memory. This volatile memory also includes additional higher levels of volatile memory, including cache memory, registers and buffers. Data that populates system memory 136 includes information handling system 100's operating system (OS) 138 and application programs 144. OS 138 includes a shell 140, for providing transparent user access to resources such as application programs 144. As depicted, OS 138 also includes kernel 142, which includes lower levels of functionality for OS 138, including providing essential services required by other parts of OS 138 and application programs 144, including memory management, process and task management, disk management, and mouse and keyboard management.

The hardware elements depicted in information handling system 100 are not intended to be exhaustive, but rather are representative to highlight essential components required by the present invention. For instance, information handling system 100 may include alternate memory storage devices such as magnetic cassettes, digital versatile disks (DVDs), Bernoulli cartridges, and the like. These and other variations are intended to be within the spirit and scope of the present invention.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

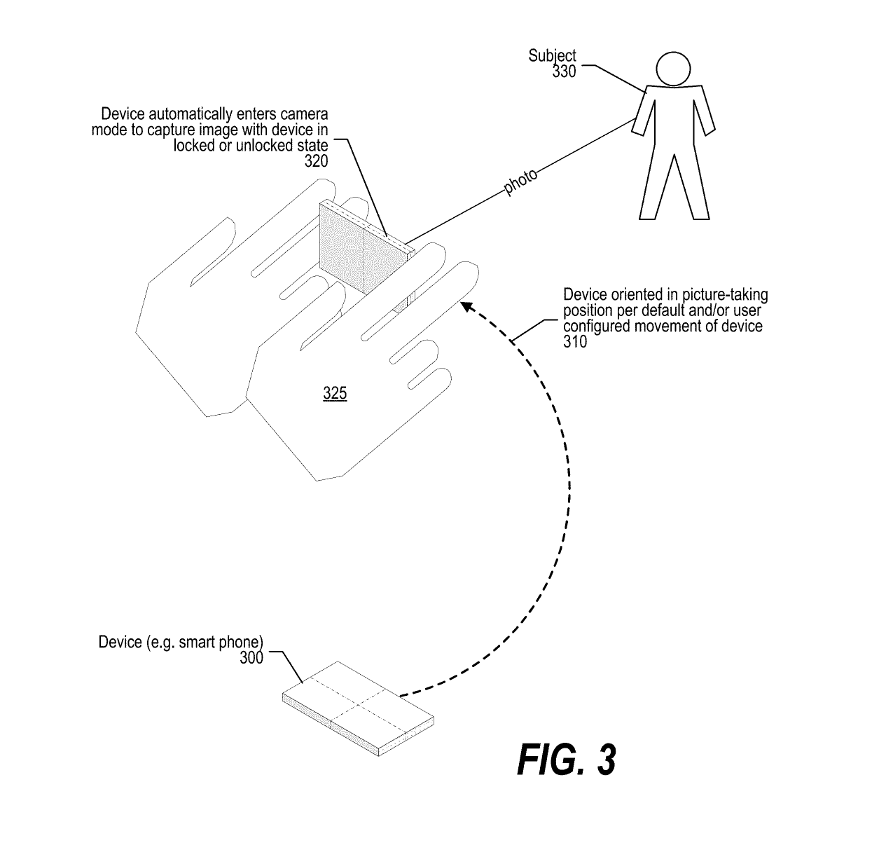

FIG. 3 is a diagram depicting components used in an approach that captures digital images at a locked device responsive to motion detected at the locked device. Device 300, such as a smart phone, etc., is in a locked state. User of the device 325 moves the device in order to take a digital image of an object, such as subject 330. The device detects the motion with motion 310 being either the device being oriented in a image-taking position or in a user-configured position. Due to the particular motion of device 300, at position 320, the device automatically enters camera mode in order to capture a digital image desired by the user. When in camera mode, an image request can be sent to the device, such as by the user pressing a image-taking trigger on the device (e.g., soft key, button, etc.). Even though the camera in the device is activated and image taking is allowed, other functionality of the device, such as other smart phone functionality, is inhibited until the user is authenticated (e.g., fingerprint, pass code, etc.). This allows user 325 to capture a digital image of subject 330 in a quick fashion without having to take the time to unlock the device.

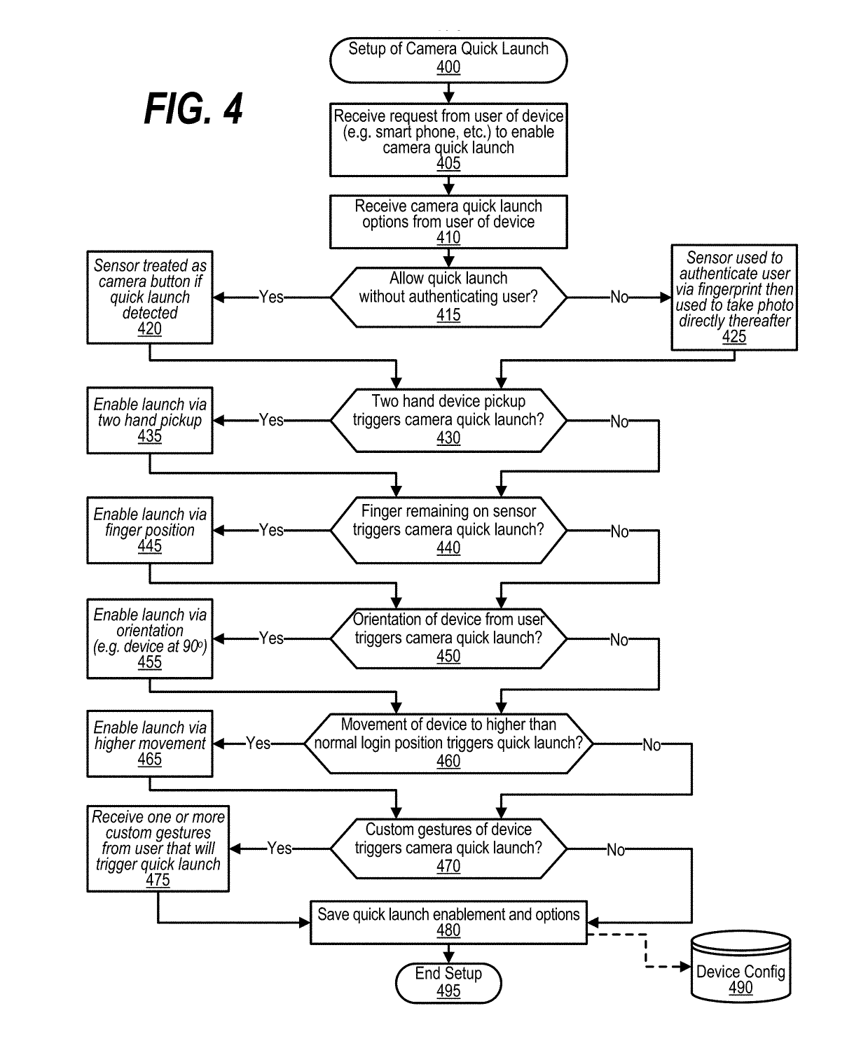

FIG. 4 is a flowchart showing configuration steps used to set up user preferences at a device in order to capture digital images at the device responsive to detected device motion. FIG. 4 processing commences at 400 and shows the steps taken by a process that sets up camera quick launch functionality on a device, such as a smart phone. At step 405, the process receives a request from the user of the device (e.g. smart phone, etc.) to enable camera quick launch functionality on the device that allows camera usage while the device is in a locked state. At step 410, the process receives one or more camera quick launch options from the user of the device.

The process determines as to whether the user wishes to allow quick launch functionality on the device when locked without first authenticating the user (decision 415). If the user wishes to allow quick launch functionality on the device when locked without first authenticating the user, then decision 415 branches to the ‘yes’ branch to perform step 420. On the other hand, if the user does not wish to allow quick launch functionality on the device when locked without first authenticating the user, then decision 415 branches to the ‘no’ branch to perform step 420. At step 420, the process sets a setting so that one or more sensors on the device are treated as the camera trigger (e.g., shutter) button when quick launch detected at the device. In this manner, any sensors on the device, such as the entire touch screen surface, can be treated as the camera trigger button so that the user does not have to remember or search for the trigger button when quickly capturing an image of a subject. At step 425, the process treats sensors in their traditional manner, such as a fingerprint sensor being used to authenticate the user and the normal camera trigger is used to receive the image request when quick launch is detected.

The process determines as to whether the user has indicated that a two hand device pickup triggers the camera quick launch functionality (decision 430). If the user has indicated that a two hand device pickup triggers the camera quick launch functionality, then decision 430 branches to the ‘yes’ branch to perform step 435. On the other hand, if the user has not indicated that a two hand device pickup triggers the camera quick launch functionality, then decision 430 branches to the ‘no’ branch bypassing step 435. At step 435, the process enables quick launch functionality to be triggered when a two handed pickup of the locked device is detected.

The process determines as to whether the user has not indicated that a finger remaining on the fingerprint sensor automatically triggers camera quick launch functionality (decision 440). If the user has indicated that a finger remaining on the fingerprint sensor automatically triggers camera quick launch functionality, then decision 440 branches to the ‘yes’ branch to perform step 445. On the other hand, if the user has not indicated that a finger remaining on the fingerprint sensor automatically triggers camera quick launch functionality, then decision 440 branches to the ‘no’ branch bypassing step 445. At step 445, the process enables quick launch functionality to be triggered when the user's finger remains on the sensor.

The process determines as to whether orientation of the device from the user triggers camera quick launch functionality (decision 450). In one embodiment, orientation is in standard image taking orientation where the camera is roughly face high with the camera lens facing a subject and the flat surface of the device roughly perpendicular to the ground. If orientation of the device from the user triggers camera quick launch functionality, then decision 450 branches to the ‘yes’ branch to perform step 455. On the other hand, if orientation of the device from the user does not trigger camera quick launch functionality, then decision 450 branches to the ‘no’ branch bypassing step 455. At step 455, the process enables quick launch functionality to be triggered when orientation of the device is detected, such as the device being roughly perpendicular to the ground.

The process determines as to whether movement of the device to a position higher than a normal login position triggers quick launch functionality (decision 460). When not capturing images, when the user wants to use the device he or she raises the device to a lower position and looks down on the device when performing authentication actions, such as providing a fingerprint or pass code with this position being roughly one foot or more lower than the user's head. If the movement of the device is to a higher position, such as the same height as the user's head or higher, then this option would automatically trigger the camera quick launch functionality. If movement of the device to a position higher than a normal login position triggers quick launch functionality, then decision 460 branches to the ‘yes’ branch to perform step 465. On the other hand, if movement of the device to a position higher than a normal login position does not trigger quick launch functionality, then decision 460 branches to the ‘no’ branch bypassing step 465. At step 465, the process enables quick launch functionality to be triggered when the device is moved to a higher position than when device login activities are performed.

The process determines as to whether the user wishes to customize one or more movements of the device that will trigger camera quick launch functionality (decision 470). If the user wishes to customize one or more movements of the device that will trigger camera quick launch functionality, then decision 470 branches to the ‘yes’ branch to perform step 475. On the other hand, if the user does not wish to provide any customized movements that trigger camera quick launch functionality, then decision 470 branches to the ‘no’ branch bypassing step 475. At step 475, the process receives one or more custom gestures from user that will trigger quick launch. In one embodiment, the user is prompted to move the device in a movement pattern that will be saved and compared with future movements of the device so that, when matched, the camera quick launch functionality will be activated.

At step 480, the process saves all of the camera quick launch enabled function settings, customized movements, and options captured during steps 410 through 475. The camera quick launch settings are saved in nonvolatile memory 490 accessible from the device. Set up processing shown in FIG. 4 thereafter ends at 495.

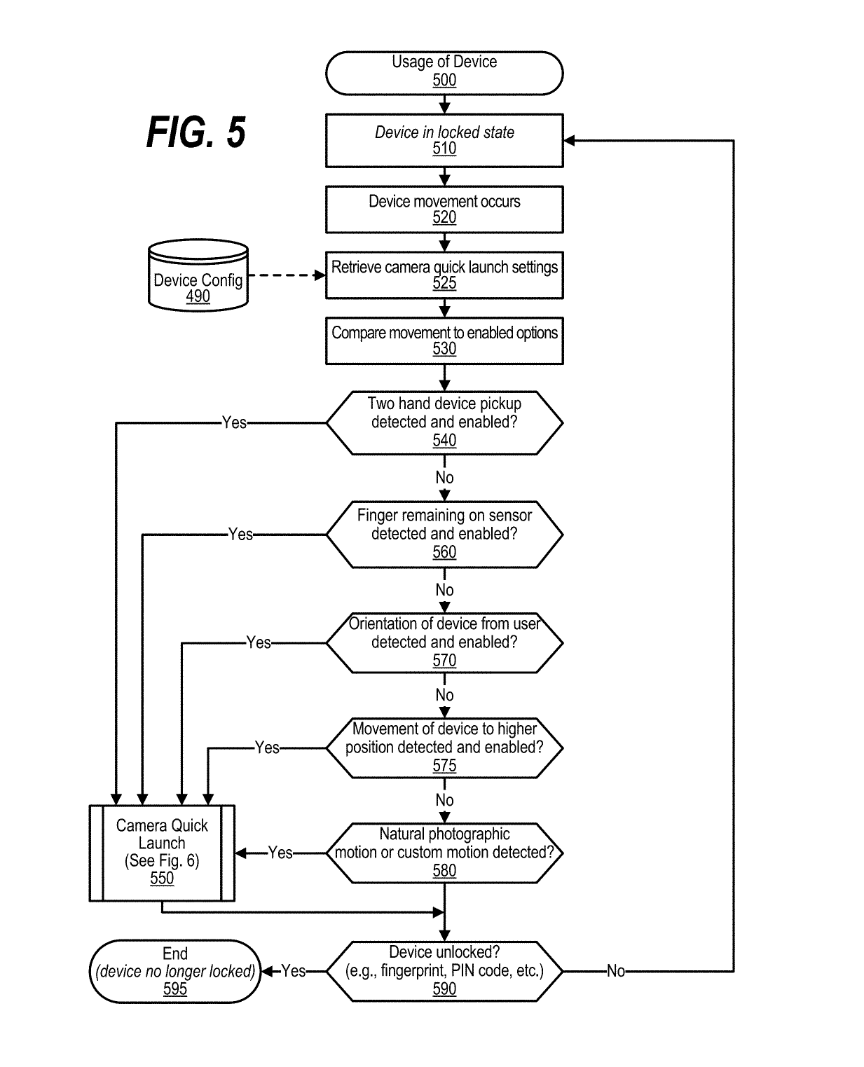

FIG. 5 is a flowchart showing steps used to capture digital images at the device responsive to detected device motion. FIG. 5 processing commences at 500 and shows the steps taken by a process that controls initiating camera quick launch functionality at a locked device, such as a smart phone. At step 510, the device is shown as being in a locked state where normal functionality is inhibited until the user is authenticated (e.g., fingerprint, pass code, etc.). At step 520, the process detects movement of the device. At step 525, the process retrieves the camera quick launch settings from data store 490. The quick launch settings were established and stored using the processing shown in FIG. 4. At step 530, the process compares the movement detected at the device to the enabled movement options that have been configured to initiate the camera quick launch functionality.

The process determines as to whether two hand device pickup motion has been detected and has also been enabled to initiate the camera quick launch functionality (decision 540). If two hand device pickup motion has been detected and has also been enabled to initiate the camera quick launch functionality, then decision 540 branches to the ‘yes’ branch to perform predefined process 550. On the other hand, if two hand device pickup motion has not been detected or has not been enabled to initiate the camera quick launch functionality, then decision 540 branches to the ‘no’ branch for further processing. The process determines as to whether the user's finger remaining on sensor motion has been detected and has also been enabled to initiate the camera quick launch functionality (decision 560). If the user's finger remaining on sensor motion has been detected and has also been enabled to initiate the camera quick launch functionality, then decision 560 branches to the ‘yes’ branch to perform predefined process 550. On the other hand, if the user's finger remaining on sensor motion has not been detected or has not been enabled to initiate the camera quick launch functionality, then decision 560 branches to the ‘no’ branch for further processing.

The process determines as to whether orientation of the device from the user motion has been detected and has also been enabled to initiate the camera quick launch functionality (decision 570). If orientation of the device from the user motion has been detected and has also been enabled to initiate the camera quick launch functionality, then decision 570 branches to the ‘yes’ branch to perform predefined process 550. On the other hand, if orientation of the device from the user motion has not been detected or has not been enabled to initiate the camera quick launch functionality, then decision 570 branches to the ‘no’ branch for further processing. The process determines as to whether motion of the device has been detected to a higher position and has also been enabled to initiate the camera quick launch functionality (decision 575). If motion of the device has been detected to a higher position and has also been enabled to initiate the camera quick launch functionality, then decision 575 branches to the ‘yes’ branch to perform predefined process 550. On the other hand, if not movement of device to higher position detected and enabled, then decision 575 branches to the ‘no’ branch for further processing.

The process determines as to whether a customized motion has been detected and has also been enabled to initiate the camera quick launch functionality (decision 580). If another natural photographic movement or a customized motion has been detected and has also been enabled to initiate the camera quick launch functionality, then decision 580 branches to the ‘yes’ branch to perform predefined process 550. Natural photographic movement include a motion to align the digital camera with a subject, a motion to place the digital camera into action, a two-handed pickup of the device, a movement of the device to a predetermined orientation from a user of the device, a movement of the device to a position higher than a normal usage height, and a detection of a fingertip on a sensor that signals an image capture.

On the other hand, if a natural photographic movement or a customized motion has not been detected or has not been enabled to initiate the camera quick launch functionality, then decision 580 branches to the ‘no’ branch for further processing. The process determines as to whether the device has been unlocked by the user (decision 590), such as by providing an authorized fingerprint or pass code. If the device has been unlocked, then decision 590 branches to the ‘yes’ branch whereupon processing ends at 590 as the usage functions shown in FIG. 5 are performed on the device when in a locked state. On the other hand, if the device has not been unlocked, then decision 590 branches to the ‘no’ branch which loops back to step 510 to repeat the processing shown above until the device is unlocked.

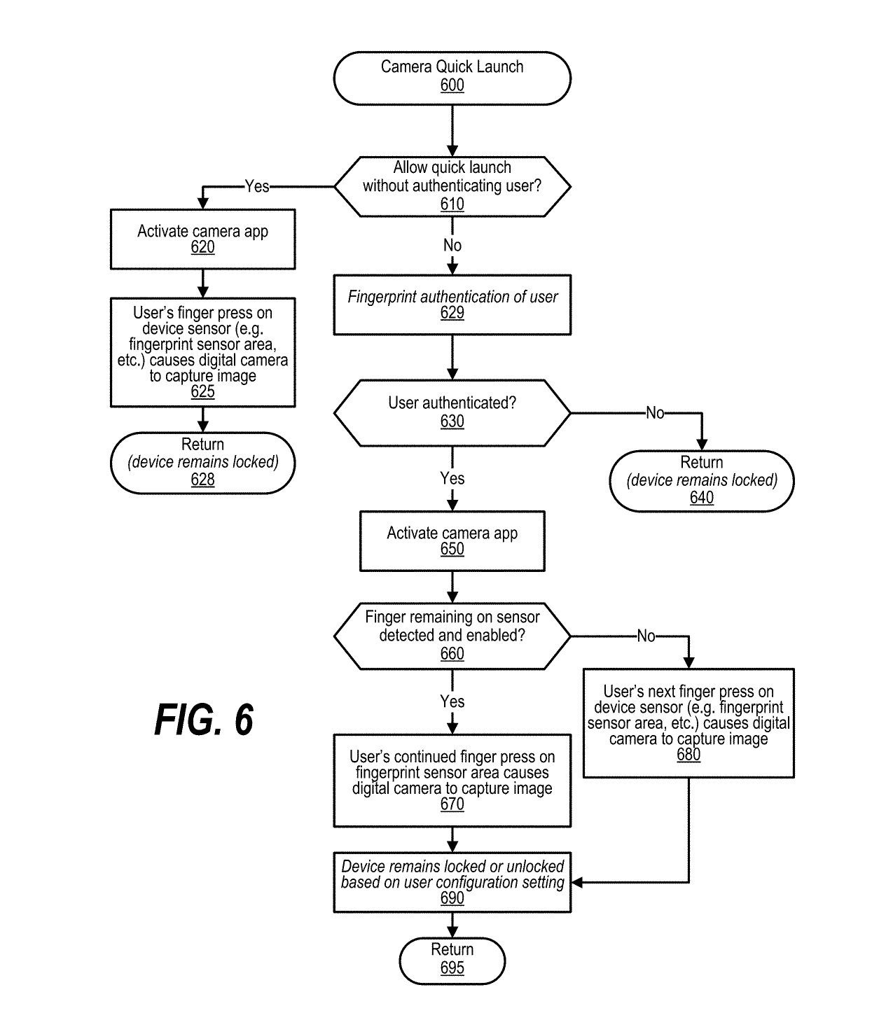

FIG. 6 is a flowchart showing steps used to perform digital camera quick launch functionality responsive to detected motion. FIG. 6 processing commences at 600 and shows the steps taken by the process that performs a quick launch of the camera application (app) on a device, such as a smart phone, that is in a locked mode, or setting. The process determines as to whether the device has been configured to allow a quick launch of the device's camera without first authenticating the user of the device (decision 610). If the device has been configured to allow a quick launch of the device's camera without first authenticating the user of the device, then decision 610 branches to the ‘yes’ branch to perform steps 620 through 628. On the other hand, if the device has not been configured to allow a quick launch of the device's camera without first authenticating the user of the device, then decision 610 branches to the ‘no’ branch to perform steps 630 through 695.

Steps 620 through 628 are performed when the device has been configured to allow a quick launch of the device's camera without first authenticating the user of the device. At step 620, the process activates the camera application (or “app”) on the device. If the camera app is already executing, then step 620 task switches to the camera app, and if the camera app is not yet executing, then step 620 invokes the camera app and task switches to the camera app. At step 625, the process waits for a finger press by the user on a device sensor (e.g. fingerprint sensor area, etc.), which causes the digital camera to capture image. In one embodiment, a single image can be captured before authentication of the user is required, while in an alternative embodiment, the camera app stays active for additional image captures but the user cannot task switch out of the camera app without first being authenticated to the device (e.g., fingerprint check, input of pass code, etc.). FIG. 6 processing thereafter returns to the calling routine (see FIG. 5) at 628.

Steps 629 through 695 are performed when the device has been configured to not allow a quick launch of the device's camera without first authenticating the user of the device. At step 629, the process authenticates the user (e.g., fingerprint check, pass code entry, etc.). The process determines as to whether the user was successfully authenticated at step 629 (decision 630). If the user was successfully authenticated, then decision 630 branches to the ‘yes’ branch to perform steps 650 through 695. On the other hand, if the user was not authenticated, then decision 630 branches to the ‘no’ branch whereupon processing returns to the calling routine (see FIG. 5) indicating that an authentication error occurred and the device remains in a locked state.

Steps 650 through 695 are performed when the user has been successfully authenticated. At step 650, the process activates the camera application (or “app”) on the device. If the camera app is already executing, then step 650 task switches to the camera app, and if the camera app is not yet executing, then step 650 invokes the camera app and task switches to the camera app. The process determines as to whether detection of the user's finger remaining on the sensor has occurred and if this quick launch feature has been enabled (decision 660). If the user's finger is detected as remaining on the sensor and if this quick launch feature has been enabled, then decision 660 branches to the ‘yes’ branch to perform step 670. On the other hand, if the user's finger is not detected as remaining on the sensor or if this quick launch feature has not been enabled, then decision 660 branches to the ‘no’ branch to perform step 680. At step 670, the user's continued finger press on the sensor area (e.g., the fingerprint sensor, etc.) causes the digital camera to capture an image. At step 680, the user's next finger press on the device sensor causes digital camera to capture image. At step 690, the devices remains locked or unlocked based on the user's configuration setting. FIG. 6 processing thereafter returns to the calling routine (see FIG. 5) at 695.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
detecting a motion at a locked device that includes a digital camera, wherein the motion detected is a user fingertip that remains on a sensor during the movement;
inhibiting access to non-camera functionality of the device while the device is locked;
receiving an image request at the locked device following the detection, wherein the sensor is a trigger that signals the image request; and
capturing a digital image using the digital camera of the locked device.

2. (canceled)

3. (canceled)

4. (canceled)

5. (canceled)

6. (canceled)

7. (canceled)

8. An information handling device comprising:
one or more processors;
a memory accessible by at least one of the processors;
a digital camera accessible by one or more of the processors;
a set of instructions stored in the memory and executed by at least one of the processors to:
detect a motion at a locked device that includes the digital camera, wherein the motion detected is a user fingertip that remains on a sensor during the movement;
inhibit access to non-camera functionality of the device while the device is locked;
receive an image request at the locked device following the detection, wherein the sensor is a trigger that signals the image request; and
capture a digital image using the digital camera of the locked device.

9. (canceled)

10. (canceled)

11. (canceled)

12. (canceled)

13. (canceled)

14. (canceled)

15. A method comprising:
detecting a natural photographic motion at a device that includes a digital camera, wherein the natural photographic motion detected is a user fingertip that remains on a sensor during the movement;
in response to the detecting, enabling an image capture process at the device;
receiving an image request at the locked device, wherein the sensor is a trigger that signals the image request; and
capturing a digital image using the digital camera of the device.

16. (canceled)

17. The method of claim 15 wherein the enabling of the image capture process further comprises:
activating the image capture process from a plurality of processes that execute on the device.

18. The method of claim 15 wherein the enabling of the image capture process further comprises:
task switching from a first activated process to the image capture process.

19. The method of claim 18 further comprising:
task switching from the image capture process back to the first activated process after the capturing of the digital image.

20. (canceled)
